(19) United States
(12) Patent Application Publication
(10) Pub. No.: US 2023/0025773 A1
(43) Pub. Date: Jan. 26, 2023

(54) Systems and Methods for Providing a Merchant Advertising Platform

(71) Applicant: Luke J. Niemela, Taylors, SC (US)

(72) Inventor: Luke J. Niemela, Taylors, SC (US)

(21) Appl. No.: 17/957,510

(22) Filed: Sep. 30, 2022

Related U.S. Application Data
(63) Continuation of application No. 17/233,147, filed on Apr. 16, 2021.
Application No. 17/233,147 is a continuation of application No. 15/802,962, filed on Nov. 3, 2017, now abandoned.

(51) Int. Cl. G06Q 30/02; G06Q 40/02; G06Q 50/00

(52) U.S. Cl. CPC G06Q 30/0233; G06Q 30/0224; G06Q 40/02; G06Q 50/01; G06Q 30/0206; G06Q 30/0269; G06Q 30/0215

(57) ABSTRACT

Systems and methods for a merchant advertising platform for generating targeted advertisements to participants in a rewards program who are able to accumulate, manage, and redeem marketing incentives using a rewards platform. Users are able to designate at least one reward sub-account, and publish corresponding information such as purchasing preferences for the sub-account. The platform enables advertisers to view the published information, generate targeted advertisements based on the user's purchase preferences, and compete with other product and service providers for the user's business. The platform, therefore, has the potential to increase the value of the user's accumulated rewards through an open and competitive marketplace.

### RELATED APPLICATION DATA

This application is a continuation-in-part application to, and claims priority to, U.S. patent application Ser. No. 17/233,147, filed Apr. 16, 2021, which is a continuation to, and claims priority to, U.S. patent application Ser. No. 15/802,962, filed Nov. 3, 2017, the entirety of all of which are being hereby incorporated by reference.

### TECHNOLOGICAL FIELD

The present disclosure relates generally to systems and methods for providing a merchant advertising platform that enables product and service providers to target advertisements to users who designate purchase preferences in connection with the accumulation and management of monetary value, such as marketing incentives in a rewards program.

### BACKGROUND

The marketplace contains a multitude of loyalty and reward programs. Many current programs provide users the ability to earn rewards by making purchases over a period of time. These rewards may be coupons, rebates, gifts, or gift cards, as provided by the program designer.

With certain reward programs, there may be shortcomings that do not adequately provide users with options for customizing, collaborating with others, and/or receiving competitive choices when redeeming accumulated reward balances. Users may find it beneficial to socialize and publish certain information regarding their account and thereby increase the value of their reward account. Likewise, product and service providers may find it useful to know customer purchasing preferences so they can target such customers with advertisements that align with the preferences.

Therefore, it is desirable to offer users a better rewards program experience that enhances the value of saved rewards and provides an efficient and effective advertising network for merchants who can compete for the users' business.

### SUMMARY

The systems and methods described herein provide for user-customization and definition, and the ability to create multiple reward designations referred to herein as reward “sub-accounts” in which rewards can accumulate and be used for specified purposes, as desired. Users' sub-account information is shared with others and with participating merchants who may provide matching goods/services at competitive rates in exchange for the equivalent value in accumulated rewards.

The following is a non-exhaustive list of examples, which may or may not be claimed, of the subject matter according to the present disclosure. A method of providing a merchant advertisement platform is provided including the steps of enabling a first user to accumulate and store a first monetary value in a first user-defined sub-account, enabling the first user to define and electronically publish a goal for the first sub-account, enabling at least first and second merchants to distribute respective advertisements for products or services to the first user relating to the first user's goal for the first sub-account, enabling the first and second merchants to view each other's advertisements and competitively adjust pricing of their respective products or services, and enabling the first user to redeem the first monetary value towards the purchase of products or services advertised by the first or second merchants.

The goal may be a product or service purchase goal, and the first monetary value may be in a non-cash rewards format that corresponds with the monetary value. The method further includes the steps of enabling the first user to redeem the non-cash rewards for cash value and enabling monitoring of the pricing of the products or services advertised by the first and second merchants based on the first user's goal for the first sub-account.

In an additional implementation of the present disclosure, the method includes the steps of enabling the first user to accumulate and store a second monetary value in a second user-defined sub-account, and enabling the first user to transfer monetary value to, from, or between the first sub-account and the second sub-account. The method may further include the steps of enabling a second user to accumulate and store a third monetary value in a third user-defined sub-account and enabling the first user and second user to create a group based on a similar goal in the first and second users' respective sub-accounts. The method may enable the first user and the second user to share information with one another regarding their respective sub-accounts, or enable the first user to transfer the monetary value from the first sub-account to the third sub-account managed by the second user. Additionally, the method may enable additional users to view, comment on, or communicate with the first user regarding the first sub-account in accordance with permission-based settings defined by the first user. The first user may transfer monetary value in the first sub-account to a different user's sub-account in exchange for receiving goods or services.

In yet another implementation of the present application, a system is provided including at least one computing device with memory running software applications designed with interfaces to enable a merchant advertisement platform. The system enables a first user to accumulate and store a first monetary value in a first user-defined sub-account, enables the first user to define and publish a goal for the first sub-account, enables at least first and second merchants to distribute respective advertisements for products or services to the first user relating to the user's goal for the first sub-account, enables the first and second merchants to view each other's advertisements and competitively adjust pricing of their respective products or services, and enables the user to redeem the first monetary value towards the purchase of products or services advertised by the first or second merchant.

### BRIEF DESCRIPTION OF DRAWINGS

FIG. 1 is a block diagram of a user account containing three (3) different reward sub-accounts which can be manipulated and defined by the user in accordance with an example implementation of the present invention;

FIG. 2 is a block diagram of a user's reward sub-account in accordance with an example implementation of the present invention;

FIG. 3 is a block diagram of a user's reward sub-account displaying user sharing and communication settings specific to this reward sub-account in accordance with an example implementation of the present invention;

FIG. 4 is a block diagram of a user's reward sub-account displaying comments and encouragements from other users in accordance with an example implementation of the present invention;

FIG. 5 is a block diagram of a user's reward sub-account displaying metrics to the user to help monitor progress and achieve the goal specific to this reward sub-account in accordance with an example implementation of the present invention;

FIG. 6 is a block diagram of a user's reward sub-account displaying relevant advertisements shown in a single display, based primarily on provided user reward sub-account information in accordance with an example implementation of the present invention;

FIG. 7 is a block diagram of a user's reward sub-account displaying relevant competitive advertising in separate ad displays, based primarily on user reward sub-account information in accordance with an example implementation of the present invention;

FIG. 8 is a block diagram of a user's ability to transfer some or all balances from one reward sub-account to at least one other user's reward sub-accounts through either one-way or two-way permissions in accordance with an example implementation of the present invention;

FIG. 9 illustrates an apparatus that according to some implementations may be configured to at least partially implement a computer, or controller system in accordance with example implementations; and

FIG. 10 is a schematic view of an edge computing system in accordance with example implementations of the present disclosure.

Each figure shown in this disclosure shows a variation of the embodiments presented, and only differences will be discussed in detail.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Also, something may be shown or described as being to a first, second, third or the like should not be taken to imply a specific order, unless otherwise stated.

Further, although reference may be made herein to a number of measures, predetermined thresholds and the like such as dollar amounts, units, percentages and the like, according to which aspects of example implementations may operate; unless stated otherwise, any or all of the measures/predetermined thresholds may be configurable. Like reference numerals refer to like elements throughout.

Example implementations of the present disclosure are generally directed to a system and method wherein users may issue, accumulate, and/or store rewards earned by the user or a plurality of other users. Users may store rewards in one or more designated reward sub-accounts designed to encourage and promote reaching certain savings goals, which may later be traded towards the purchase of goods or services. Users may accumulate rewards based on performing certain activities such as, but not limited to, making purchases, using goods/services, consuming advertising, completing tasks, sharing information with others, and/or playing games of luck or skill. Users may continue to accumulate rewards from multiple third party merchants, or other users, and when certain thresholds are reached, users may trade such rewards towards the purchase of good/services provided by other users. Users may also use rewards in other ways including, but not limited to, transferring to a third party bank account, transferring directly to a merchant as payment for goods/services, or transferring to others as desired.

Creating Multiple Reward Sub-Accounts

Example implementations of the present disclosure are generally directed to a system and method for storing accumulated rewards in at least one customizable sub-account by a user. The systems and methods may provide a more meaningful way for users to create multiple reward savings sub-accounts and customize them to include, as examples, titles, descriptions, goals, intended uses, interests, and the like. A user's creation of more than one reward sub-account allows for better organization, control, and storage of accumulated rewards.

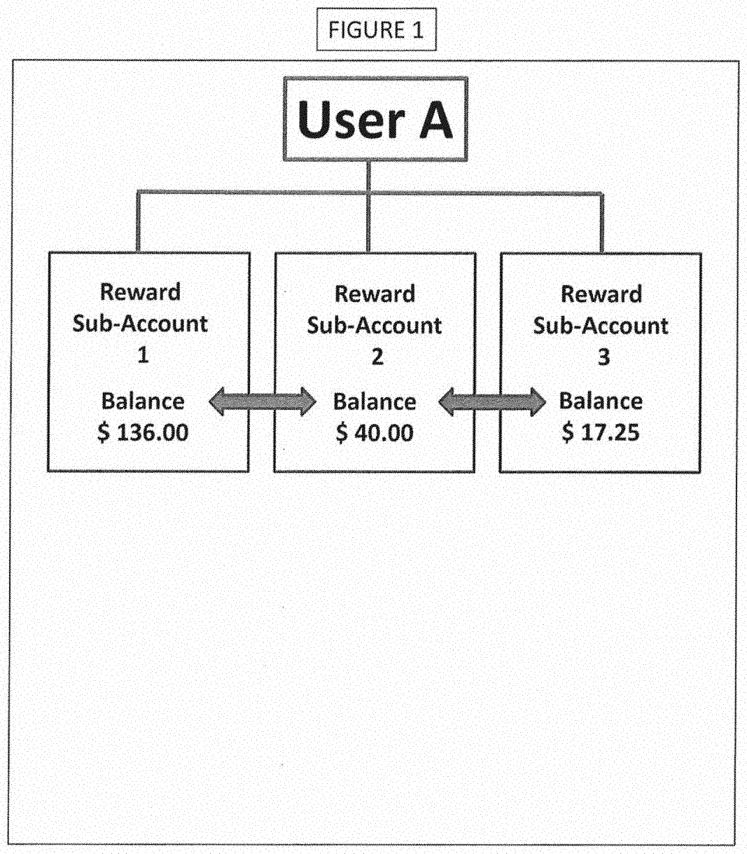

In FIG. 1, an example implementation of the present disclosure is depicted as a block diagram of a single user “User A,” who has created three (3) separate reward sub-accounts inside his or her reward account. In this example, reward sub-account 1 comprises a $136 reward balance, reward sub-account 2 comprises a $40 reward balance, and reward sub-account 3 comprises a $17.25 reward balance. As indicated in the example, the system may be configured such that sub-account balances and other information may be transferred between the reward sub-accounts.

Descriptions of Reward Sub Accounts

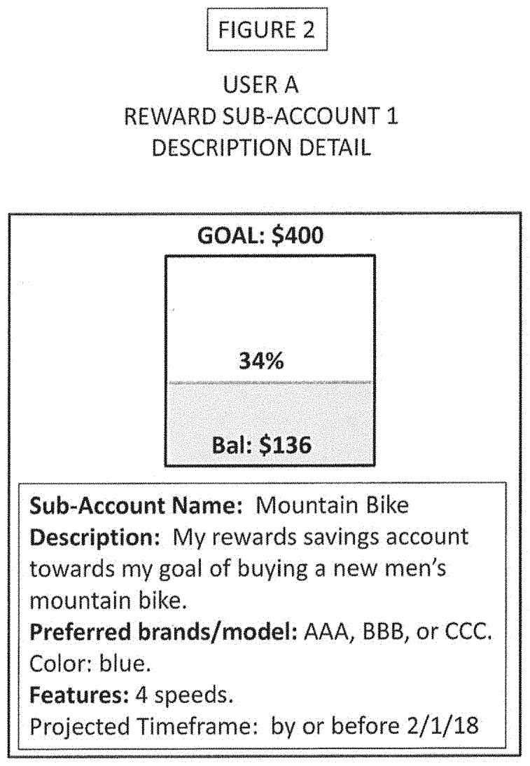

According to example implementations of the present disclosure, the system may be configured to enable one or more users to create labels, descriptions, and/or goals for each reward sub-account. Specifically, the system may be configured to enable the one or more users to create titles and descriptions that relate to the intended use or goal of the particular reward sub-account. As shown in the example in FIG. 2, the system may be configured such that a user (“User A”) may create a reward sub-account designed specifically for saving towards the goal of purchasing a new bicycle. In that case, by way of example, User A may title the reward sub-account “Mountain Bike,” and add an appropriate description such as preferred brand, color, and/or other suitable features.

As further shown in FIG. 2, the system may be configured to enable the reward sub-account to display User A's reward savings goal ($400) for this specific reward sub-account, the current balance of the sub-account ($136), and/or the percent to goal based on the current balance (34%). The system may be configured to enable the reward sub-account to track and display a timeframe by which the user or users wants to attain the specified saving goal. In the example shown in FIG. 2, by way of example, User A desires to purchase the new mountain bike by or before the specified date of Feb. 1, 2018.

As referenced above, the system may be configured such that a reward sub-account may be set-up to save for any type of financial goal, such as, for example, saving for vacation, birthday gifts, paying bills, etc. In instances where the savings are intended to be shared with recipients (such as a birthday gift), the reward sub-account may be configured to electronically transfer the desired amount directly to the intended recipient(s) via suitable means such as, e.g., electronic bank transfer, PayPal, and/or other suitable means.

Publishing & Viewing Reward Sub Accounts

The system may be configured to enable the implementation and/or configuration of one or more permissions for users to publish certain information pertaining to their respective reward sub-accounts with others. The system may be configured to enable the one or more users to manage such publishing through an interface, and may be configured to set permissions specific to each reward sub-account.

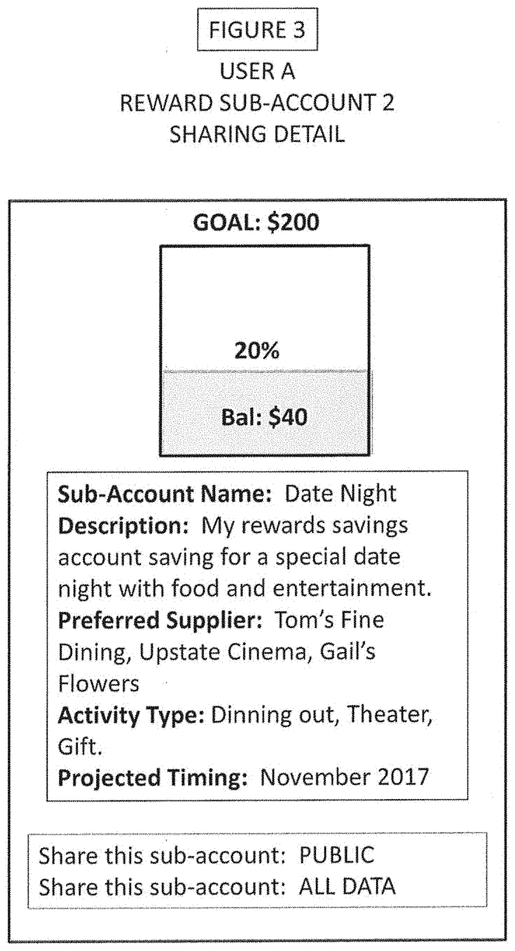

As shown in FIG. 3, users may desire to create settings to allow others to view some or all of the details pertaining to their reward sub-account(s). The system may be configured to enable the one or more users to create such settings. In this example, User A has set this reward sub-account to share “all data” available with the “public.” The one or more users may find that publishing certain information is entertaining or encouraging. The one or more users may also find that publication of their goals helps them to reach their reward savings goals more quickly. Such publishing and sharing may be with at least one other user or groups of users, and the publication may occur within the systems described herein or through other third party programs such as online social networks, internet search engines, communication applications/networks, SMS text messages, electronic mail, advertising mediums, and other preferred methods of communication as desired by the one or more users.

In another implementation of the present disclosure, the system may be configured to enable the one or more users to create and/or join one or more groups with other users who are similar and/or have similar reward sub-accounts. Being a part of such a group could create additional encouragement and support for users working towards similar goals, and in turn, increase usage. Such systems and methods may provide peer-to-peer influence and mutual support and thereby increase usage of the systems and methods described herein.

In another aspect of the present disclosure, the system may be configured to enable the one or more users to comment on, make reference to, or otherwise communicate to other users regarding statuses of their own reward sub-accounts or the reward sub-accounts of others. As users publish certain information regarding their reward sub-accounts, the system may be configured to enable others to provide comments, reference, or discuss these in detail with one another.

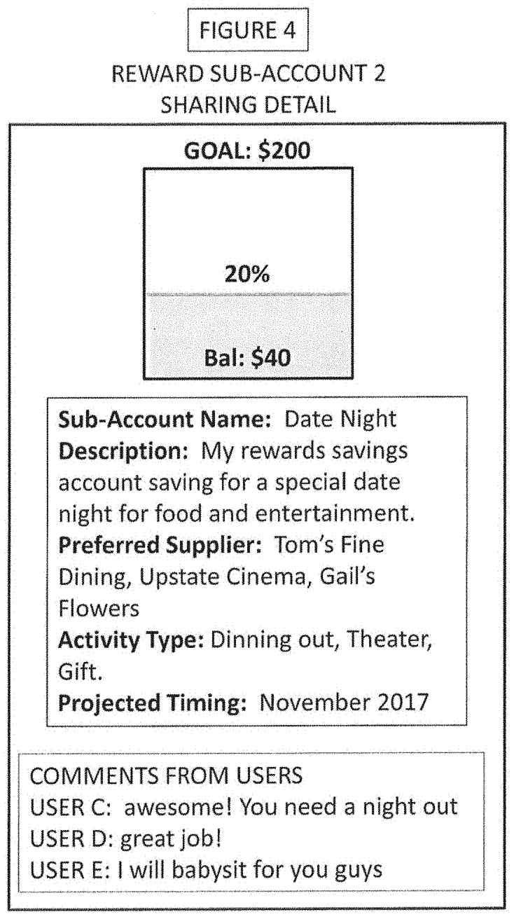

In the example shown in FIG. 4, the system may be configured to enable the reward sub-account to display one or more comments submitted from various users. As such, the system may be configured to enable User A to read and/or reply to such comments as desired. Such communication may enhance the user experience and encourage additional use.

Reward Sub-Account Metrics

The system may be configured to enable data to be optionally displayed to one or more users, wherein the data is reflective of the then-current status of the one or more users' reward sub-accounts.

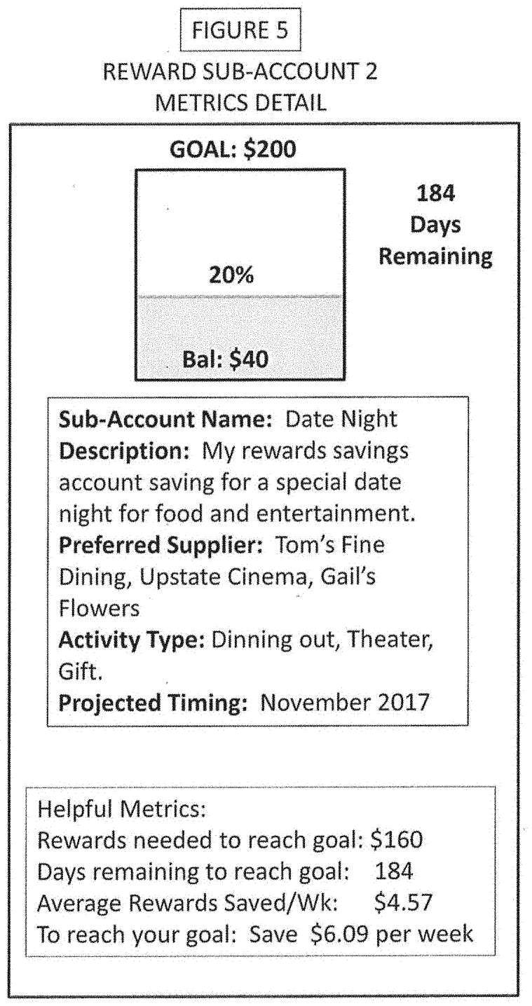

As shown in FIG. 5, such measurements and totals may aid the user in managing his reward sub-account and/or reach his reward savings goal within the desired timeframe. Users may find the data helpful in achieving reward savings goals, comparing their reward progress to other users, and encouraging increased use of the systems and methods. In addition to data pertaining to the user's own reward sub-account(s), data may also be provided that compares one user's reward sub-account(s) to other users and provide comparisons. Such data may comprise, but is not limited to: current balance, goal, percent to goal, time remaining, balance averages per day or week, milestones, analyses of reward sub-account, and/or other relevant and/or suitable data. Comparing users to other users may increase the frequency of use for a user and encourage the accumulation of additional rewards.

Advertising Network and Marketplace

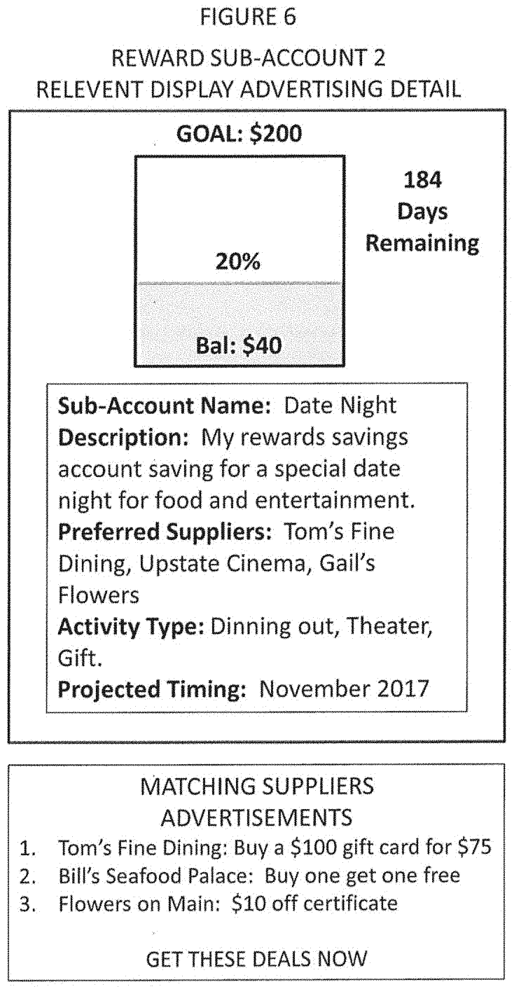

The system may be configured to enable promotion and/or advertisement opportunities for goods and/or services to at least one user matching desired criteria. According to various embodiment, the system may be configured to make aware, to an advertising merchant (product or service provider), referred to herein as an “advertiser,” aspects of certain user's reward sub-accounts containing similar descriptions relevant to goods and services provided by an advertiser. Thus, the system may be configured to display advertisements from various merchants offering complementary products based on the published reward sub-account description. For example, referring again to FIG. 1, a bicycle shop may be made aware of the User A's desire to purchase a new mountain bike. In the example shown in FIG. 6, restaurants and florists are made aware of the user's goal of having a special date night.

The system may be configured to enable an advertiser to promote its goods and/or services to users matching its targeted audience at a price which is less than the same may be presented in others in other markets. For example, an advertiser may determine the reduced price of the goods/service based upon data provided within the system described herein. Such data may comprise, but is not limited to, reward sub-account goal amounts, current balances of reward sub-accounts, descriptions, competitor pricing, etc. As advertisers promote their goods/services to users, they compete against others to win some or all the user's accumulated rewards in exchange for the user's purchase of its goods or services (such as Tom's Fine Dining competing against Bill's Seafood Place as shown in FIG. 6).

According to various embodiments, the system may be configured to generate, for one or more 3^{rd} parties (e.g., one or more merchants) one or more advertisements for products or services based on a user's goal or goals. According to various embodiments, the advertisements for products or services are targeted explicitly to a user, based on the user's goal or goals.

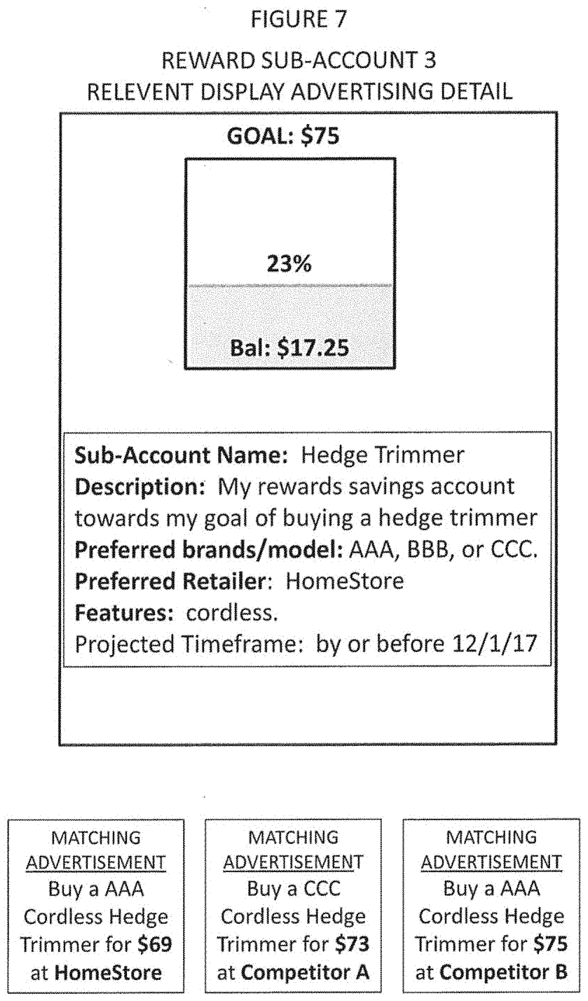

In the example shown in FIG. 7, multiple merchants are competing for the user's business by displaying relevant promotions based on the published reward sub-account data pertaining to the goal of purchasing a hedge trimmer.

As such, the system may be configured to enable one or more users to increase the value of their accumulated rewards and redeem those for more valuable goods or services. This exchange rate may be competitive in nature between other advertisers and users to trade for accumulated rewards of other users. The system may be configured to enable one or more users to communicate to advertisers in various stages of such negotiations as well. This will encourage users to provide and publish more information pertaining to their reward sub-accounts and as such, increase the value of accumulated rewards and thereby increasing the frequency of use of the systems and methods.

Referring again to the example in FIG. 1, a user may have indicated a goal of a particular reward sub-account is saving towards the purchase of a mountain bike, and the desired mountain bike may currently sell in the marketplace for $400, but, since advertisers are made aware of the user's interest in purchasing a mountain bike, the advertiser may offer its mountain bike at a price of $350, in an effort to entice the user to exchange the appropriate amount of his accumulated rewards for the advertiser's mountain bike. This amount could be all or some of the user's accumulated rewards to be used towards the purchase price of the goods or services. Thus, an advertiser may win more business over other competitors while a user increases the value of his accumulated rewards. Another example may be a financial institution offering a user a bonus to open a new account using the value of his accumulated rewards.

The ability for a user to receive competitive offers from advertisers may enhance the user experience and increase the value of accumulated rewards, thus leading to increased use of the systems and methods. Furthermore, advertisers may gain increased sales of its goods and services from users.

According to various embodiments, the system may be configured to enable advertisers to choose to advertise specific goods/services to certain users or groups of users or may choose to advertise a discount off a total shopping order or a range of goods/services selected by the user. Advertisers may also find groups advantageous through advertising matching goods and services to the group and offer a more competitive price when one or more users in the group agree to purchase advertised goods/services.

Transferring Rewards to Others

According to various embodiments, the system may be configured to permit one or more users to transfer accumulated rewards to and from at least one other user. The system may be configured to enable users to create settings that allow certain users to make transfers to or from one or more reward sub-accounts. A user may find it beneficial to have the ability to transfer rewards to or from at least one other user on a one-time basis or on set intervals. Transferring rewards could be automatic based on user-defined preconfigured parameters, or through manual settings. Users may find it beneficial to transfer accumulated rewards to at least one user, for reasons including, but not limited to; transferring to a relative, a friend, an employee, providing a gift to another user, making a donation to a charity, and other similar instances. Accumulated rewards contain some monetary value and therefore having a method by which to transfer all or some rewards to another user or group of users, may be beneficial and increase usage by a user.

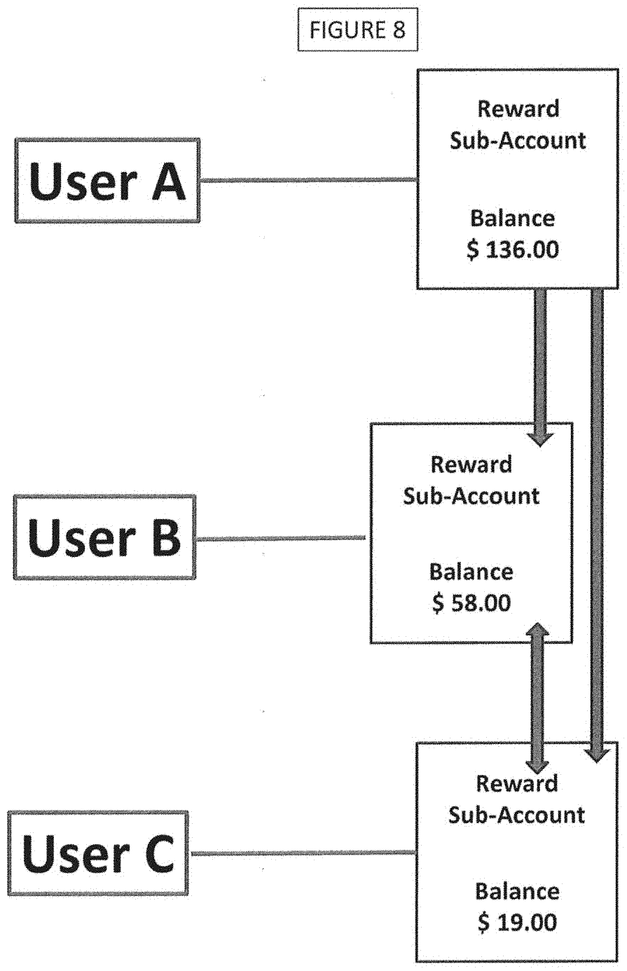

In FIG. 8, an example implementation of the present disclosure is depicted of multiple users transferring certain rewards amongst their reward sub-accounts. As shown, User A has the ability to transfer certain rewards from one of his/her reward sub-account to one of User B's reward sub-account in a one-way transaction. Also in this example, both Users B & C may transfer in and out of the other's designated reward sub-account. User A has the ability to transfer rewards to one of User C's reward sub-accounts. As reference above, a user may desire to transfer rewards in to or out of reward sub-account to or from third party accounts or programs. It may be desirable for users to transfer rewards in from other third party accounts, such as, but not limited to; other loyalty programs, other reward programs, merchant accounts, bank accounts, investing accounts, electronic game reward accounts, online reward programs, employee programs, cryptocurrency (e.g., digital currency i.e. Bitcoin, Ripple, Litecoin), and the like. In some cases, third party programs may provide an exchange rate, favorable to the user, when transferring to and from the systems described herein.

Redeeming Rewards

According to various embodiments, the system may be configured to enable one or more users to redeem rewards, including permitting users to transfer accumulated rewards to another user's (or users') reward sub-account. For example, one user may desire to transfer some or all of his accumulated rewards from one or more of his reward sub-accounts to another user's reward sub-accounts for reasons including, but not limited to in exchange for goods/services, donating rewards, gifting, paying bills (such as utilities, internet, cable television, etc), and the like.

According to various embodiments, the system may be configured to enable one or more users to redeem rewards by permitting users to transfer accumulated rewards to an account at a financial institution at an agreed upon exchange rate converting rewards into currency. For example, a user may decide to transfer accumulated rewards to a savings account at a bank.

In another aspect of an example implementation, users transfer accumulated rewards to third party online accounts, including but not limited to; social funding, crowd-funding, and the like.

According to various embodiments, the system may comprise an interface 402 containing settings in which a user may pre-configure certain parameters for automatic or manual redemption and/or transference of rewards to a user or non-user. An example may include, but not be limited to, transferring rewards to another based on a timed interval, transferring rewards to another based on achieving a certain threshold, or transferring rewards to another as a means of purchasing goods and/or services for immediate purchase, payment for past purchases, and/or payment for future purchases.

The term “reward” and the plural form of this term as used herein could also mean any bonuses, discounts, credits, coupons, vouchers, marketing incentives, fees provided, kick-backs, refunds, payments, rebates, cryptocurrency, and the like, provided by a merchant to a user. Rewards may be expressed in terms of currency, for example dollars and cents, as used herein, or could also be expressed as points, credits, cryptocurrency, or the like.

The terms “user”, “merchant”, “advertiser”, “consumer”, and the plural form of these terms as used herein could also mean; a consumer, an individual, a for-profit business, a not-for-profit business, an organization, an association, a charity, a religious organization, merchant, a financial institution, a service provider, a manufacturer of goods, and any person, or entity (including both individuals and businesses) capable of accessing, using, benefiting from, or being affected by the systems and methods described herein.

The terms “redeem rewards”, “use rewards”, “exchange”, “trade”, and the plural form of these terms as used herein are used interchangeably and can have the same meaning.

Furthermore, these terms are used to generally describe the process of trading, giving, receiving, transferring, and/or exchanging a certain number of rewards to another for any reason, including but not limited to; receiving goods, using services, paying bills, giving, transferring to a user or non-user.

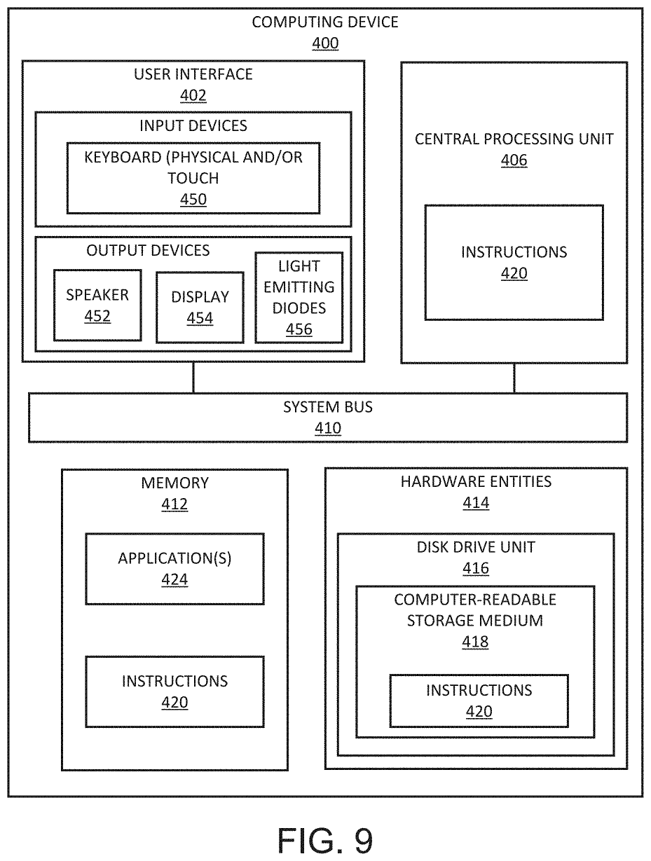

It is also to be understood that at least one computer/computing device 400, as shown in FIG. 9, is used with implementations of the systems and methods for users to accumulate, store, and manage rewards and for merchants to target advertisements to the users based on preferences stored in the rewards program, in accordance with the present disclosure. More specifically, computer system 400 may be configured to draw information from and receive inputs from other sources, and such sources could be remote and received through wire or wireless connection with the Internet or communications via other means including, but not limited to, microwave, radio frequency, Bluetooth, hardwire, electricity transmission lines, telephone, and/or other available communication modalities.

FIG. 9 illustrates an example architecture for a computing device 400. According to various embodiments, the computing device 400 may function as a control system of the present disclosure. The computing device 400 may be configured to partially or wholly implement the operation of the systems and methods described herein. Generally, the apparatus of exemplary implementations of the systems of the present disclosure may comprise, include or be embodied in one or more fixed, portable or embedded electronic devices.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which facilitate user-software interactions for controlling operations of the computing device 400. The input devices may comprise, but are not limited to, a physical and/or touch keyboard 450. The input devices may be connected to the computing device 400 via a wired or wireless connection (e.g., a Bluetooth® connection). The output devices may comprise, but are not limited to, a speaker 452, a display 454, and/or light emitting diodes 456.

The processor 406 may generally be any piece or component of computer hardware that is capable of processing information such as, for example, data, computer-readable program code, instructions or the like (at times generally referred to as “computer programs,” e.g., software, firmware, etc.), and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 412 (of the same or another apparatus).

At least some of the hardware entities 414 perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which is stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400. The memory 412 and the CPU 406 also may constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the computing device 400 and that cause the computing device 400 to perform any one or more of the methodologies of the present disclosure.

The processor 406 may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 412 may generally be any piece or component of computer hardware that is capable of storing information such as, for example, data, computer programs (e.g., computer-readable program code 420) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disc—read only memory (CD-ROM), compact disc—read/write (CD-R/W), digital versatile disc (DVD) or other standard media and format. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory 412, the processor 406 may also be in electronic communication with one or more of the user interfaces 402 (e.g., communication interfaces) configured for displaying, transmitting, and/or receiving information. The communications interface 402 may be configured to transmit and/or receive information, such as to and/or from other apparatus(es), network(s) or the like. The communications interface may be configured to transmit and/or receive information by physical (wireline) and/or wireless communications links. Examples of suitable communication interfaces include a network interface controller (NIC), wireless NIC (WNIC) or the like.

As indicated above, program code instructions may be stored in memory, and executed by a processor, to implement functions of the systems, subsystems and their respective elements described herein. As may be appreciated, any suitable program code instructions may be loaded onto a computer comprising hardware and software, or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus. Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an apparatus 400 may include a processor 402 and a computer-readable storage medium or memory 412 coupled to the processor, where the processor is configured to execute computer-readable program code 420 stored in the memory. It will also be understood that one or more functions, and combinations of functions, may be implemented by special purpose hardware-based computer systems and/or processors which perform the specified functions, or combinations of special purpose hardware and program code instructions.

Different examples of the systems and methods disclosed herein include a variety of components, features, and functionalities. It should be understood that the various examples of the systems and methods disclosed herein may include any of the components, features, and functionalities of any of the other examples of systems and methods disclosed herein in any combination, and all of such possibilities are intended to be within the spirit and scope of the present disclosure.

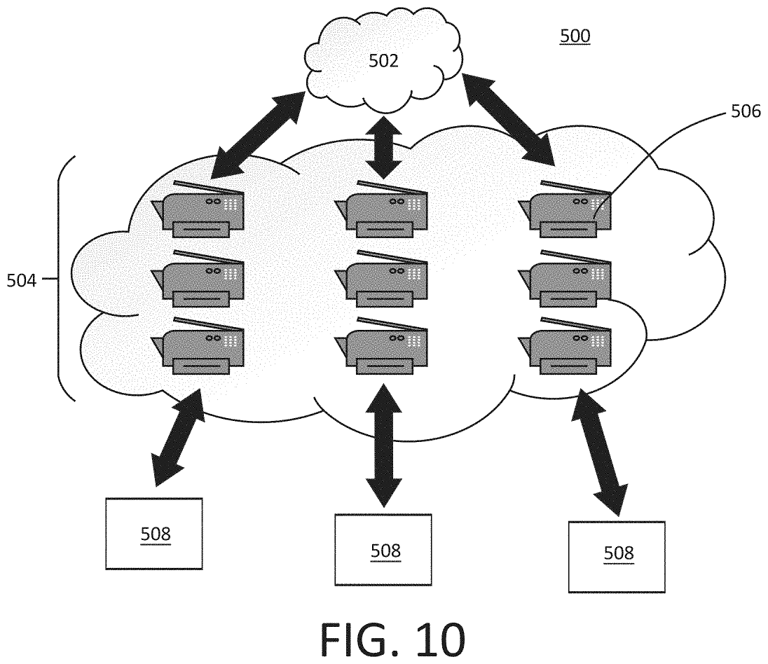

Referring to FIG. 10, an edge computing system 500 is illustratively depicted, in accordance with various embodiments of the present disclosure.

According to various embodiments, computer device 400 can function with, or act as a component of (e.g., node 506) edge computing system 500.

According to various embodiments, the edge computing system 500 includes one or more computing devices 508 and one or more edge nodes 506, within an edge layer 504, centrally connected to the cloud 502. According to various embodiments, each of the one or more computing devices 508 may be similar and/or identical to computing device 400 and/or may comprise one or more components present within computing device 400.

One or more of the connections between any of the components of the edge computing system 500 may be wired, wireless, and/or a combination of wired and wireless. Each node 506 may also comprise one or more of a processor (e.g., processor 402) and a memory (e.g., memory 412).

According to various embodiments, one or more of the nodes 506 can be placed near one or more computing devices 508. A series of nodes 506 may be placed near certain computing devices 508, with the result that the work performed by each node 506 is performed faster than if the same amount of work were to be performed by one centralized location in the cloud 502. This system of hardware and software enables the time needed for processing the transaction data to be decreased while removing and/or decreasing network lag times.

The more time that is needed in order for a computing system to complete the required tasks, the longer each process, of the systems and methods described herein, takes to complete, thereby decreasing the number of possible transactions and/or sales that can be completed in a given timeframe and potentially delaying a customer and/or business and/or causing customer frustration and/or business frustration, which can also lead to decreased customer satisfaction and sales. Accordingly, it is desirable to reduce or eliminate lag times in order to increase efficiency for the user and to further enable multiple users and businesses to communication and/or transact amongst each other using the systems and methods described herein.

Detrimental issues with cloud computing alone include computer processing delays, causing inefficiencies, downstream delays and/or increased computer process wait times. Processing data from thousands of computing devices 508 without impacting computer processing speeds can be a large task and can require software that can route traffic during peak times, perform the necessary computer processing, and return the data quickly and efficiently. The speed at which the data would need to be processed and returned is preferably within a fraction of a second.

In previous systems, 3rd party systems are often used to process transactional data, which requires a physical server in every store location that could only process data based on rules that were preloaded and updated perhaps only once per day, or weekly. This can make launching or changing programs in real-time particularly difficult or not feasible.

In order to correct for this issue, using the edge computer system 500 (as shown, e.g., in FIG. 18) allows nearby nodes to be updated, as needed, anytime, and in real-time. Given the potential amount of data transferred, and the speed at which such data must be processed, scalable servers, robust software, and a network of computing nodes 506 permit this process to work, whereby transactional data can be sent in real-time to these nodes 506 on the edge layer 504, and be processed quickly and returned, thus improving upon the data processing speed of existing technologies and systems and being more efficient than existing technologies.

According to various embodiments, each computing node 506 is in electronic communication with one or more of the computing devices 508. According to various embodiments, the greater the number of nodes 506 available for each computing 508, the less the computing power and/or energy consumption needed for each processor of the one or more computing nodes 506 to execute the one or more programming instructions in the memory. According to various embodiments, the computing nodes 506 are configured such that an increase in a number of computing nodes 506 decreases an overall timeframe needed to execute the one or more programming instructions.

According to various embodiments, the workload of the computer system, using an edge computing structure (such as, e.g., shown in FIG. 10) allows for parallel processing of data and also allows for the spread of the workload of the computer system 500 across the plurality of nodes 506, decreasing computing time due to each node 506 only handling local traffic, which, in turn, causes less data to be used or processed. By the nodes 506 being connected closer to the computing devices 508 than a centralized location in the cloud 502, latency is further reduced, since data traffic is potentially traveling through less physical distance and/or through a reduced number of individual networks, relays, switches, etc. than would be the case using cloud 502 alone. With a network having a centralized location in the cloud 502, all (or near all) traffic is potentially being routed to one central stack in the cloud 502, and potentially requiring larger servers scaling up and/or down, based on the amount of data traffic, resulting in the data traffic having to travel through more obstacles, thereby slowing data speeds. In contrast, with edge computing, the edge layer 504 of the system 500 could be proximate to and connected with the computing devices 508.

Accordingly, for at least these reasons, the systems, methods, and devices of the present disclosure improve upon the existing technologies in the consumer purchasing field and advertisement generation field, and, moreover, significantly improve upon an existing problem in the field that has not been addressed by current systems. In particular, the present systems and methods not only enable users to define purchasing goals, but also enable a plurality of merchants to view these goals and view the advertisements of other merchants to both compete with each other and improve the sales experience of the user. Thus, Applicant's claimed systems and methods greatly improve upon both the purchase of goods by and services by users and the advertising and supplying of goods and services to users.

Many modifications and/or other implementations of the disclosure set forth herein will come to mind to one skilled in the art to which these disclosures pertain having the benefit of the teachings presented in the foregoing descriptions and the associated drawings. Therefore, it is to be understood that the disclosures are not to be limited to the specific implementations disclosed and that modifications and other implementations are intended to be included within the scope of these disclosures. As an example, while the foregoing description references the accumulation and management of rewards, the present invention is not limited to non-cash rewards. Rather, actual cash value could be accumulated and managed in the account, and used for the basis of publicizing purchase goals. Additionally, non-cash rewards can be redeemed or exchanged for actual for cash value.

Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method of providing a merchant advertisement platform comprising the steps of:
storing, in a memory of a first computing device, a first monetary value of a first user in a first user-defined sub-account, wherein the first computing device includes a processor;
enabling, via the processor, the first user to accumulate and store a second monetary value in a second user-defined sub-account;
receiving, from one or more communications interfaces, and publishing, via the processor, a goal for the first sub-account;
generating, via the processor, for at least first and second merchants, advertisements for products or services relating to the first user's goal for the first sub-account;
transmitting the advertisements to the first user;
enabling, via the processor and the one or more communications interfaces, the first and second merchants to view each other's advertisements and the first user's goal to competitively adjust pricing of the first and second merchants' respective products or services and transmit the adjusted pricing to the first user; and
enabling, via the processor, the first user to redeem the first monetary value towards the purchase of products or services advertised by the first or second merchants by transmitting the first monetary value from the first computing device to a second computing device controlled by the first or second merchant;
wherein the first monetary value is earned by the first user based on prior purchase activity, and
wherein the first monetary value and the second monetary value are in a non-cash rewards format that corresponds with the monetary value.

2. The method of claim 1, wherein the goal is a product or service purchase goal.

3. The method of claim 1, further comprising the step of enabling the first user to redeem the non-cash rewards for cash value by transmitting the first monetary value from the first computing device to a third computing device controlled by a financial institution.

4. The method of claim 1, further comprising the step of enabling, via the processor, monitoring of the pricing of the products or services advertised by the first and second merchants based on the first user's goal for the first sub-account.

5. The method of claim 1, further comprising the step of enabling, via the processor, the first user to transfer monetary value to, from, or between the first sub-account and the second sub-account.

6. The method of claim 1, wherein the advertisements for products or services are targeted to the first user, based on the first user's goal for the first sub-account.

7. The method of claim 1, further comprising the steps of:
enabling, via the processor, a second user to accumulate and store a third monetary value in a third user-defined sub-account; and
enabling, via the processor, the first user and second user to create a group based on a similar goal in the first and second users' respective sub-accounts;

8. The method of claim 7, further comprising the step of enabling, via the processor, the first user and the second user to share information with one another regarding their respective sub-accounts.

9. The method of claim 8, further comprising the step of enabling, via the processor, the first user to transfer the monetary value from the first sub-account to the third sub-account managed by the second user.

10. The method of claim 1, further comprising the step of enabling, using the processor, each of the at least first and second merchants to view the advertisements for products or services generated for other of the at least first and second merchants.

11. The method of claim 1, further comprising the step of enabling, via the processor, additional users to view, comment on, or communicate with the first user regarding the first sub-account in accordance with permission-based settings defined by the first user.

12. The method of claim 1, further comprising the step of enabling, via the processor, the first user to transfer monetary value in the first sub-account to a different user's sub-account in exchange for receiving goods or services.

13. A system for providing a merchant advertisement platform, the system comprising:
one or more communication interfaces;
a processor; and
a memory,
wherein the memory includes computer instructions that, when executed, cause the processor to:
accumulate and store, for a first user, a first monetary value in a first user-defined sub-account;
accumulate and store, for a second user, a second monetary value in a second user-defined sub-account;
receive and publish, via the one or more communication interfaces, a goal for the first sub-account;
enable, via the one or more communication interfaces, at least first and second merchants to:
view the goal for the first sub-account;
distribute respective advertisements for products or services to the first user relating to the first user's goal for the first sub-account;
view each other's advertisements; and
competitively adjust pricing of their respective products or services based on the first user's goal and each other's advertisements; and
enable, via the one or more communication interfaces, the first user to redeem the first monetary value towards the purchase of products or services advertised by the first or second merchant by transmitting the first monetary value from a first computing device to a second computing device controlled by the first or second merchant;
wherein the first monetary value is earned by the first user based on prior purchase activity, and
wherein the first monetary value and the second monetary value are in a non-cash rewards format that corresponds with the monetary value.

14. The system of claim 13, wherein the advertisements for products or services are targeted to the first user, based on the first user's goal for the first sub-account.

15. The system of claim 13, wherein the computer instructions, when executed, further cause the processor to enable each of the at least first and second merchants to view the advertisements for products or services generated for other of the at least first and second merchants.

16. A system for providing a merchant advertisement platform, the system comprising:
one or more edge nodes in electronic communication with one or more computing devices, each edge node comprising:
one or more communication interfaces;
a processor; and
a memory,
wherein the memory includes computer instructions that, when executed, cause the processor to:
accumulate and store, for a first user, a first monetary value in a first user-defined sub-account;
accumulate and store, for a second user, a second monetary value in a second user-defined sub-account;
receive and publish, via the one or more communication interfaces, a goal for the first sub-account;
enable, via the one or more communication interfaces, at least first and second merchants to:
view the goal for the first sub-account;
distribute respective advertisements for products or services to the first user relating to the first user's goal for the first sub-account;
view each other's advertisements; and
competitively adjust pricing of their respective products or services based on the first user's goal and each other's advertisements; and
enable, via the one or more communication interfaces, the first user to redeem the first monetary value towards the purchase of products or services advertised by the first or second merchant by transmitting the first monetary value from a first computing device to a second computing device controlled by the first or second merchant;
wherein the first monetary value is earned by the first user based on prior purchase activity, and
wherein the first monetary value and the second monetary value are in a non-cash rewards format that corresponds with the monetary value.

17. The system of claim 16, wherein the advertisements for products or services are targeted to the first user, based on the first user's goal for the first sub-account.

18. The system of claim 16, wherein the computer instructions, when executed, further cause the processor to enable each of the at least first and second merchants to view the advertisements for products or services generated for other of the at least first and second merchants.
